(19) United States
(12) Patent Application Publication
(10) Pub. No.: US 2008/0195451 A1
(43) Pub. Date: Aug. 14, 2008

(54) AUTOMATED DATA MANAGEMENT FOR PERFORMANCE REPORTS

(75) Inventor: John E. Abram, West Yorkshire (GB)

Correspondence Address: KNOBBE MARTENS OLSON & BEAR LLP, 2040 MAIN STREET, FOURTEENTH FLOOR, IRVINE, CA, 92614, US

(73) Assignee: Monetical Limited, Cambridge (GB)

(21) Appl. No.: 12/028,695

(22) Filed: Feb. 8, 2008

Related U.S. Application Data
(60) Provisional application No. 60/900,643, filed on Feb. 9, 2007.

(51) Int. Cl. G06Q 10/00

(52) U.S. Cl. 705/8

(57) ABSTRACT

A system for enhancing the predictive value of planning of a pending project based upon data from historical projects, the system comprising means for storing historical data in a manner that permits later extraction of such data based upon similarity of characteristics, the means comprising a plurality of sectors into which data from similarly situated historical projects maybe stored, and means for extracting certain subsets of historical data for purposes of performing statistical analyses on such data to enhance project planning as needed throughout the pendency of the pending project.

### CROSS-REFERENCE TO RELATED APPLICATIONS

This application is a non-provisional application claiming priority to Provisional Application No. 60/900,643, filed on Feb. 9, 2007, the entire contents of which is incorporated herein by reference.

### BACKGROUND OF THE INVENTION

1. Field of the Invention

The present invention relates to project management tools and specifically to improvements in data management designed to make the management of projects more efficient and effective.

2. Description of the Related Art

Although there is a growing array of software project management tools available to a project manager, each time a project team embarks on a new project, very little post-project analysis is performed. This results in the failure to identify how key project characteristics and combination of project characteristics effected the eventual performance. That failure makes it more difficult to accurately predict how a new project will be impacted by the same or similar characteristics.

There are at least three main characteristics by which a project is materially impacted: scope (e.g., functional capacity), schedule (e.g., completion date), and budget (e.g., financial investment). Project planners often plan for a contingency value, e.g. 10%, for the budget, but overlook contingency values for scope and schedule. In other cases, contingencies are set for schedule and budget but not for scope. Moreover, to the extent that a contingency is considered for each characteristic, a flat value is often employed.

It has been suggested that project planners should instead be prepared to accept varying levels of variation for each of these three factors, depending on project maturity (i.e. life cycle status: introduction, growth, mainstream, decline & cessation) and project type (complexity: from a hot fix to a completely new solution). This approach would allow project owners to perform far more meaningful analysis and derive the most suitable project profile based on current performance objectives, project type and historical influences.

The principal reason for the lack of historical data analysis is that current project tools do not accommodate the recording and analysis of all appropriate data. To the extent that it is desired to carry out such an analysis, it is very time consuming to do so. Moreover, not all project managers have the skill to analyze all permutations. Thus, current project management methodology does not exploit historical data from other related projects to improve the accuracy of future project planning. The consequence is that each new project is approached as though it were the first, resulting in the project performing similarly to others with little gains in efficiency and effectiveness.

There are at least two principal challenges before a project planner can exploit existing historical data: one is the historical data must be captured and analyzed; the other is decided which historical project data should be considered for the next project—i.e., which data is most relevant.

### SUMMARY OF THE INVENTION

The present invention comprises a methodology that permits project planners to exploit historical data for purposes of enhancing project planning initially and throughout the life cycle of the project. For purposes of the explanation provided herein, a project life cycle will be presumed to comprise a creation stage, at least one but more likely several change stage, a closure stage, and an archival stage. At the creation stage of a new project, and at each change point subsequent thereto, relevant historical data is extracted from a knowledge pool that comprises a compilation of data obtained from historical projects and stored in a manner that associates the data with its corresponding stage in historical projects from which it came. That data may be extracted when the project manager faces unplanned or unscheduled changes, or on a regular basis at predefined intervals, e.g., each week. This way, the most current data is made available as the new project progresses through the project time line.

When the data from the knowledge pool is extracted, it is then analyzed to establish:

predicted variations of three important characteristics of a project; namely, scope, schedule and budget—for each parameter to generating multiple permutations of possibilities; by example a parameter could be the experience level of a particular project manager, or the number of team members;

identify the key inference to project performance;

the available alternative project characteristics, as defined in the conditional profiler, crosschecking with the preconfigured levels of variation (LSL—lower specification limit, and USL—upper specification limit); and

the best-fit revised project make-up, which primarily entails a change of project parameters or attributes (e.g., meet more often, assign a different manager, add more team members, etc.), and possibly project characteristics as constrained by the conditional profiler.

This automated analysis is possible because the methodology comprises a conditional profiler for each project, which itself comprises (i) a defined set of acceptable levels of variation for project characteristics (e.g. scope USL=+2%, schedule LSL=1.5%, and budget=+3.5%), and (ii) the project parameters that can or cannot be changed (e.g., frequency of project meetings by one level, years of experience of project manager). These two sets of values are predefined either for a single project or for multiple projects. It is contemplated that the conditional profiler could be updated during the course of the project to reflect additional historical data added to a knowledge pool of such data.

The present invention has particular applicability to software projects, but it is also applicable to other types of projects that have, as their characteristics, a scope, a schedule and a budget.

### BRIEF DESCRIPTION OF THE DRAWINGS

FIG. 1 is a flow chart showing project life cycles and the interplay of knowledge pool data between historical projects and present projects.

FIG. 2 is a flow chart showing the flow of steps in one application of the inventive methodology as compared with prior art manual analyses.

FIG. 3 is a graphical representation of the knowledge pool data hierarchy.

FIG. 4 is a graphical user interface that reflects exemplary contents of the conditional profiler for a project.

FIG. 5 is a graphical user interface that reflects an exemplary inference report for a project.

FIG. 6 is a graphical representation of how the results of the inference table of FIG. 5 may be used (or interpreted) to generate multiple project scenarios using the inventive methodology.

FIG. 7 is a graphical representation that shows the variation fluxuation over the life of the project between project creation and product release.

### DETAILED DESCRIPTION OF THE PREFERRED EMBODIMENT

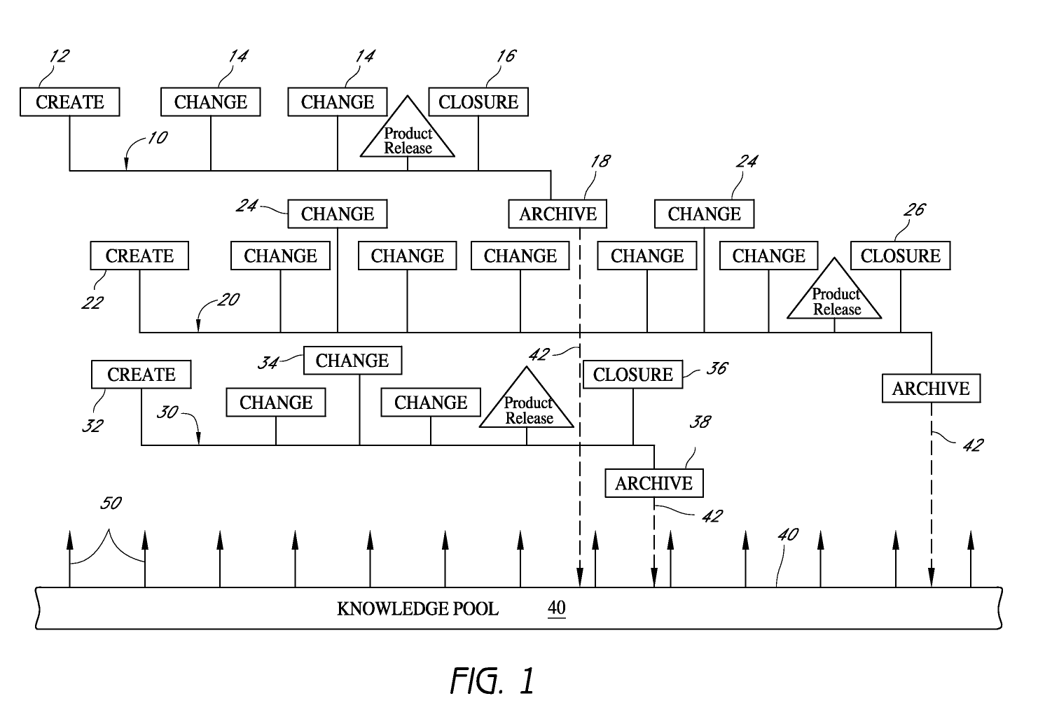

Referring to FIG. 1, a typical project life cycle 10 (stages over the life of the project) comprises project creation 12, project change 14, project closure 16 and project archive 18. This is distinguishable from a product life cycle, which necessarily includes the product design period, testing, release, technical support, etc. For purposes of the description set forth herein, product creation and project creation reflect the same time period, and product release falls between the last project change and project closure. The period between project closure an project archival, the product proceeds through its continued sales and discontinuance periods, accompanied by what may be years of technical support. At the archiving stage, it is contemplated, for example, that the company be no longer investing anymore resources into the product (i.e., no more engineering and/or marketing), even though information from technical support may continue to flow into the knowledge pool relating to that product's project.

The present inventive system and methodology ensures that all historical project performance data is considered as part of a single performance analysis. In one embodiment, the inventive system comprises a computer program created with functionality as set forth below tied to networked databases for storing historical project data. The computer program, as further described below, comprises a step-wise regression algorithm for performing statistical analyses on project parameters that impact the project characteristics (i.e., scope, schedule and budget) and the possible predictive outcomes of varying the parameters within the constraints of the conditional profiler based upon historical data from the knowledge pool, which are both preferably stored in the networked databases. The algorithm is what queries the knowledge pool and selects the appropriate data based upon the constraints of the conditional profiler; the algorithm then uses the data to generate an inference table, as described below.

With continued reference to FIG. 1, along any project timeline, there is likely to be multiple parallel projects at various stages in the life cycle, some having been closed and archived, some pending, and some in the creation stage; see projects 10, 20 and 30. In the example of FIG. 1, project 10 started prior to projects 20 and 30 and has been closed prior to the closure and archival of projects 20 and 30. Project 20, however, continues even after the closure of project 30. As with project 10, projects 20 and 30 each proceed through their respective life cycles of creation, changes, closure and archival.

It is contemplated that throughout a project, project data is uploaded into a knowledge pool 40. The knowledge pool 40 may comprise an electronic database or archival information. To make it useful, the project data is placed into the knowledge pool with accompanying metadata so that the project data can be stored for useful retrieval later. While it is contemplated that all historical data associated with a project be stored 42 into the knowledge pool 40 by the time the archival stage is reached, project data can be stored, and is desirably stored, periodically at intervals throughout the project. The relevant metadata comprises the identification of the particular project, the team and department in which the project was conducted, the stage of the product life cycle, the complexity of the project/product, the manager name, the number of locations the project team is based in, the number of regular and ad hoc meetings, the experience of the team members, and some or all other parameters used to help predict later project plans more usefully. At the time of deposit of project data into the knowledge pool, the metadata essentially reflects a cross-section of the project at that point in time with all relevant information about the project.

At regular intervals of time 50, data is extracted from the knowledge pool 40 for use by the present inventive methodology to assist a project planner and/or manager with tweaking the pending project plan to improve effectiveness and efficiency as the project proceeds through its life cycle. Such pre-emptive performance analyses consider all historical data up that moment from all projects recorded in the knowledge pool. Pre-emptive performance analysis follows the same workflow as the others. It is to be noted that the data is made available to all pending projects, although the data extracted for each project may differ depending upon the type of project and the relevance of the particular data extracted. The inventive methodology also contemplates the extraction of relevant knowledge pool data whenever unplanned and/or unscheduled changes occur or are about to occur.

In one embodiment, the creation of a new project may be triggered by a web service request from another system or from within the system application itself When this occurs, the system calls upon the appropriate knowledge repository to guarantee that sufficient historical data is used during the analysis and subsequent selection of the most appropriate model. This analysis ensures results are of statistical importance and appropriate to the new project that is being created. The scope of the knowledge repository data may be determined, e.g., by the following hierarchy: industry, business type and project type.

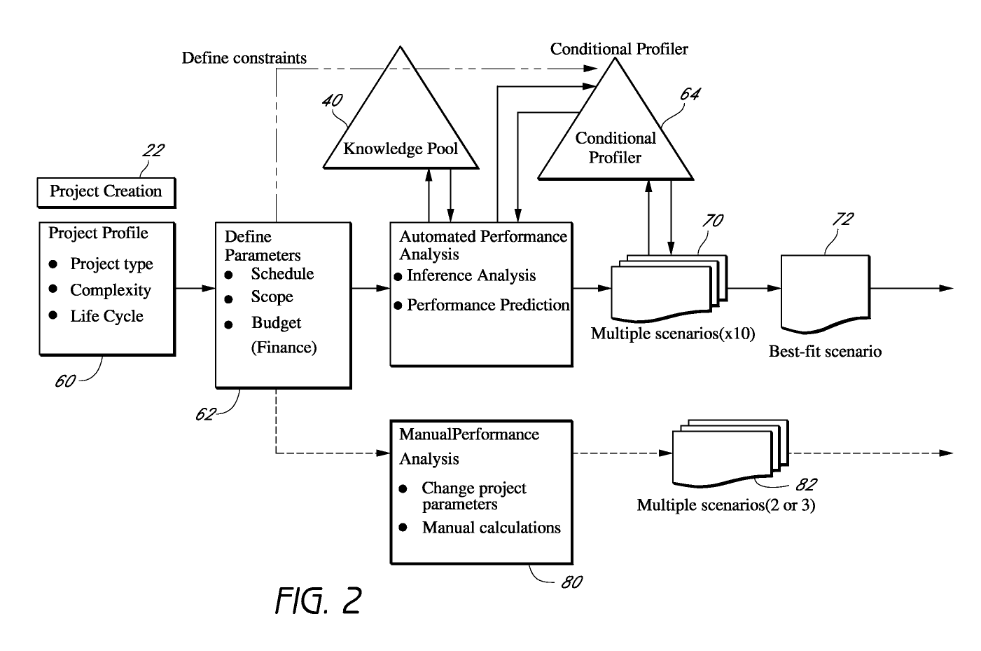

Referring to FIG. 2, the interplay of information flowing from the knowledge pool for analysis by a particular pending project can be described further. At the project creation point 22, the project profile 60 is established; specifically, the project type, the complexity of the project, and the anticipated life cycle. Following the establishment of a project profile 60, the present methodology contemplates a define parameters step 62, which comprises defining, e.g., the schedule, the scope, and the budget (and other financially relevant aspects). The scope may comprise an indication of the size of the project in terms of the number of requirements; the schedule may comprise the phase, activity and tasks to be performed and their duration; and budget may comprise not only the available funding, but the available resources involved in the project, i.e., the core team, the stakeholders and the resource pool. These project characteristics have been selected because they exhibit significant inference on the end performance of any given software project and therefore need to be constantly monitored throughout the project cycle in order to provide real-time performance reports.

At the time of project creation, and in particular at the define parameters stage 62, a conditional profiler 64 is established that sets the constraints on project parameters and the acceptable variations thereto, if any. For example, no more than a 10% budget increase may be deemed acceptable, but no variation, whatsoever, may be permitted for the schedule. The invention methodology takes advantage of the knowledge pool 40 and the conditional profiler at the creation stage and change stages by performing an automated performance analysis 68; i.e., an inference (influence) analysis and a performance prediction. This automated performance analysis 68 comprises a statistical analysis (i.e., an algorithm designed to assess how parameters influence the characteristics of a project). For example, one piece of historical data may show that whenever a particular person is given charge of a project of this type, the schedule is almost always completed on schedule, but almost always seems to exceed budget by at least 6%. The algorithm evaluates the presence of variation of each project parameter and combination. The analysis 68 is desirably performed at predetermined regular time periods and/or at unscheduled change stages during the life cycle of a project.

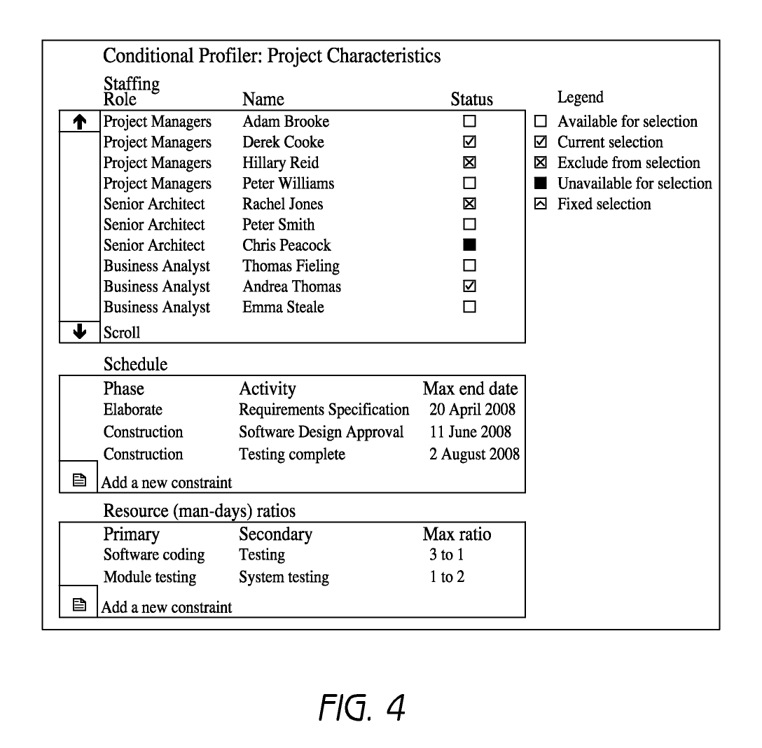

Referring to FIG. 4 for a moment, a graphic user interface reflecting a partial list of project parameters identified in the conditional profiler 64 is shown. In FIG. 4, there are three boxes of information shown in this example. The first box reflects the staffing pool for the project, the second box shows defined schedule constraints, and the third box shows defined resource constraints. Other boxes would also appear if the user were to scroll further down or up. The staffing pool box shows, by way of example, their availability to work on the project under one of several possible constraints; e.g., fully available, already on the team, to be excluded from the team, desired but not available, and must be on the team. The schedule box presents the desired target end dates for various key milestones. The resource box shows, e.g., the maximum allowed resource allocation as between two departments.

Based upon the automated performance analysis 68, multiple scenarios 70 are generated; i.e., multiple possible changes in project parameters are suggested or proposed, all of which predict how the project would proceed under its respective set of parameter variations. The suggested or proposed variations in project parameters necessarily reflect the constraints of the conditional profiler, however. So the multiple scenarios 70 reflect the analysis of historical data at similar stages of similar projects and the impact of the historical characteristics on those similar projects to predict how the variation in parameters in the pending project would impact the pending project. Because very few projects are identical, some of the scenarios of the multiple scenarios 70 may not fit as well as other scenarios in terms of their predictive value. Thus, the present inventive methodology further analyses the predictive aspects of the multiple scenarios 70 to generate a best-fit scenario 72. The project can proceed under a varied but more efficient plan until the next predetermined knowledge pool extraction is addressed or at the next unscheduled change.

The inventive approach ensures a continuous feedback loop increases the value, because more project related data is available, including data that is captured as part of a series of planned project audits. This blend of current and historical project data in the knowledge pool is exploited to create a series of additional risk assessment reports, which in turn feed a continuous improvement program across the organization. The present invention generates multiple scenarios from the rapid analysis of many historical data records held within the knowledge pool; this allows organizations to establish effective pre-emptive actions to reduce risk and increase the performance of an individual project.

By comparison with the less efficient prior art methodology, reflected by the dotted line 80 of FIG. 2, following the define parameters stage 62, the project planner or manager conducted a manual performance analysis 80 at the time of unscheduled changes to calculate how the changes would impact the balance of the project. While of some value, it lacked the input of how similar changes at similar stages of similar projects impacted those historical similar projects so that a better predictive exercise could be conducted. While multiple scenarios 82 could be generated, the number generated was much more limited than with the present methodology described herein.

With a continuous feedback process providing data on the actual—rather than projected—performance, the overall automation process and the characteristics of the statistical analysis is driven towards greater accuracy and efficiency, enabling, e.g., software organizations to optimize the performance of their operational and commercial activities. Furthermore, the accuracy of the own predictive capability is improved through continued re-factoring of its own predictive capability, based on its historical accuracy.

The present inventive methodology functions at least in part through the reiterative use of a standard set of features. With respect to input parameters, the present methodology calls upon, by example, four sets of data as input during the automated process: knowledge repositories (predefined knowledge pool, business models and root-cause map and current project profile and additionally captured project characteristics); project characteristics (type, resources, schedule, financials & scope); preconfigured time period for performance analysis, conditional profiler parameters 4.1 defining and acceptable USL/LSL variation of predicted scenario alternatives and 4.2 master constraints defining the availability of alternative project characteristics.

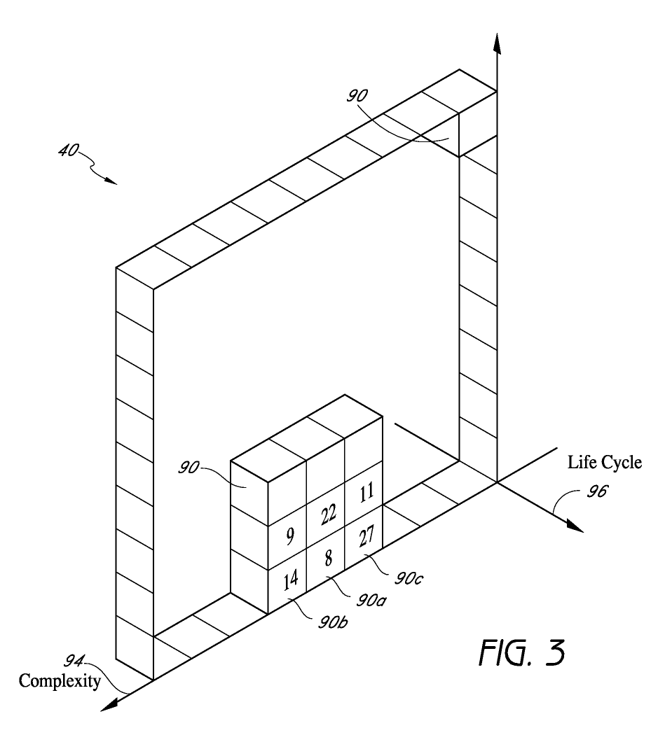

Referring to FIG. 3, the knowledge pool 40 comprises all the performance records relating to historical projects. These records are hierarchically categorized in blocks or sectors 90 of data organized, by example, in a 3-dimensional array comprising the size of the project pools 92 (ranging descriptively from current project, all related projects, all projects within the department, the organization, the community, and to all records), the complexity 94 of the project (numerically from simple to very complex), and the product life cycle 96 (numerically from project creation to, e.g., technical support of a discontinued product). Other hierarchies may be used and still serve the advantages of the inventive methodology described herein.

Within each block or sector 90 is a value that comprises the number of historical projects that share the particular complexity, product life cycle stage and project pool. By way of example, if pending project A were in phase three, had a complexity value of x, and a product life cycle value of y, sector 90a would be considered because it contains project records for similarly situated projects. In this case, sector 90a comprises eight project records in the knowledge pool 40 that may be considered as part of the automated performance analysis 68. In other words, those eight projects reflect data from historical projects also in phase three (or equivalent), having a complexity value in the range of x and a product life cycle value in the range of y. It would not be expected that the data in sector 90a would be identical to the state of project A, but they reflect data from similarly situated projects, or at least data relevant to the existing phase. In other words, it may be a historical product has been released and supported for years, but the consumer feedback and technical issues raised would still be relevant to a product at the very early stage of project development.

If those eight projects are of sufficient value to permit effective revision to the pending project plan of project A, multiple scenarios 70 may be generated from which the best-fit scenario 72 may be selected to revise the operational baseline of project A. If not, the present system dynamically expands the size of data set extracted from the knowledge pool 40 that is leveraged during the automated process. This expansion takes place as a series of boundary expansions. In other words, the system will increase the number of historical project records extracted, working outwards, to include the closest two complexity values (±1), the closest product life cycle values (±1), and/or the project pool value (±1). By way of example, with a first complexity boundary expansion, the two closest complexity values of x+1 and x−1 reflect sectors 90b and 90c. By extracting this additional data set, the total number of project records expands to 49 (8+14+27). The next increase may include all project phases, (9+22+11). Thus, as illustrated in FIG. 3, a first boundary expansion in both complexity and project phase expansion would increase the total number of historical project records by 83 (i.e., from 8 to 91). The number increases dramatically, because the inventive system is forced to increase the number of projects at the same time.

According to the present invention, this dynamic expansion cycle may continue until sufficient historical data has been extracted that is of statistical value. In this example, the next expansion cycle may take into account project of greater and lesser complexity (i.e. expanding along the z axis). The expansion process also has the opportunity to expand along the x axis, i.e. projects with different product life cycle values. An automated statistical analysis of the dramatically increased number of available historical project data permits a more refined and accurate predictive model from which to revise the current project during its life cycle. At the same time, there may be decreasing effectiveness of the present methodology and system if too much information is analyzed.

In one example, a software developer such as Microsoft could choose to take into account the historical projects data off its Office Suite (having similar complexity and life cycle) when determining the best project profile to enhance Excel, rather than taking into account historical project records from their Internet Explorer projects and departments. If Microsoft were to exploit the present system and methodology on their next Microsoft Excel v9 project, which has possibly a complexity value of 8 and a product life cycle value of 3, then all historical Excel project within these same values would be considered, before expanding to include the entire suite with the similar values, i.e. those within the department. So in project pool order:
Current Project=Excel v9, where c=8, p.l.c.=3;
All projects=Excel v1 to v9, where c=8, p.l.c.=3;
Department projects=All Office Suite projects.

When an internal or external factor is deemed likely to influence the performance of a given project, optimization analysis capabilities are invoked. The primary purpose of the optimization analysis capabilities is to ensure project groups, e.g., software organizations, are prepared to manage change in such away that it has the least impact on the project success. Success is measured by the amount of variation to the planned scope, budget and schedule. This not only calls for the correct recording of the need for variation, but also for the ability to consider new alternative project scenarios (i.e. that contain different project characteristics), measure their potential impact on the project prior to actually responding to it and then selection. In a complex software organization, especially if relying on dispersed teams, this can be a very difficult task as both the interdependencies of these dispersed resources and the financial impacts need to be considered carefully. Furthermore, existing project management tools fail to take account of historical data and do even less to evaluate the key inferences to performance of such historical projects.

It is desirable as part of the present invention that project closure reports be generated when a particular milestone is reached (typically, at the time ownership is handed to the end user). These reports may include data on the actual performance capability of a given project against the projected performance capability of the project once it is deployed and in operation. The ability to forecast performance supports the project owners determines whether the project is fit-for-release. Analysis of the release criteria is enhanced with the use of the inventive system, because it takes account of potential future support costs, as experienced by previous projects. This ability allows the project owner for example to compare immediate costs and benefits and long term costs and benefits. Although a project status may have been set to ‘closure’ records can continue to be added.

Using the inventive methodology, archiving typically occurs when the enterprise determines the project requires no further investment or support. At this point the all project related records as set to ‘read-only’, but remain available for future analysis as part of a different project performance analysis cycle. This means that they no longer take part in any scenario analysis.

With regard to the automated performance analysis 68 identified above in association with FIG. 2, inference is the process of deriving a conclusion based solely on what one already knows. The inventive system and methodology uses a number of statistical analysis methodologies, an automatic statistical procedure that analyses a large number of potential explanatory variables with no underlying theory. The output is a list of parameters that are considered to have a significant inference on project performance.

Additional statistical techniques are exploited to identify inference to project performance. The present inventive system exploits such statistical procedure to indicate the predicted root-causes (i.e., the underlying reason for the variation occurring—e.g., four more days were needed to incorporate a software feature because the original specification was lacking in complete information), and forecasts a new future performance capability. Associated with each project phase, activity or task is a predefined root-cause map (not shown). A root-cause map is a series of suggested reasons as to why any of the project parameters would undergo a change. The primary focus of performing root-cause analysis is to uncover the root cause rather than identify and address the symptom (i.e. identify resource, process or financial weaknesses and ensure the organizations takes the necessary actions to address the real problem). Typically, root-cause analysis is not fully performed within software organizations because of its complex nature and the lack of tools capable to reduce the manual burden associated to this process. An additional unique characteristic of the inventive predefined root-cause map is the supply of preconfigured corrective indicators and activities. These corrective indicators steer the organization towards making changes that reduce the likelihood these root causes causing variation in the future.

The present inventive system allows the project owner to intervene with the performance analysis process to inspect any number of scenarios that the inventive system has generated. This intervention allows the project owner to compare the automated scenarios, notwithstanding the “best-fit” scenarios being automatically presented, and select one that may not be the best fit if it meets the project owner's needs more effectively.

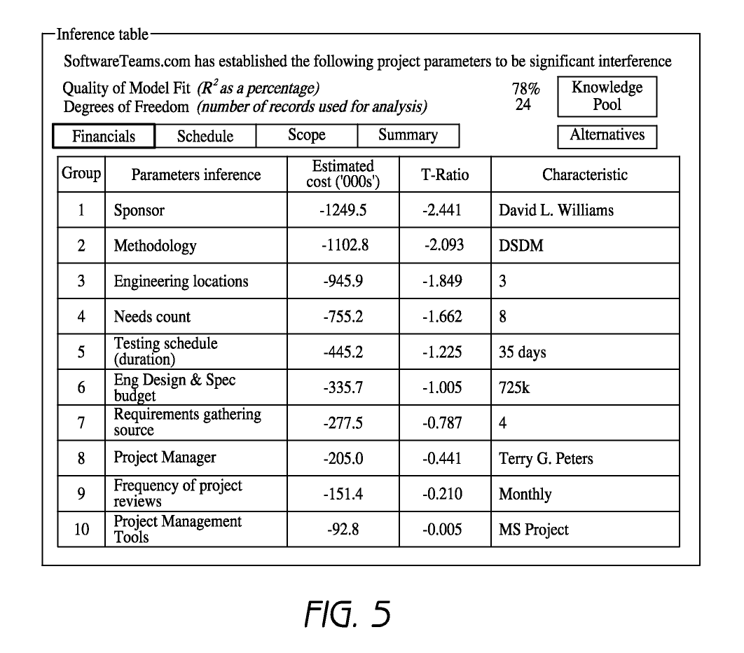

The present system and methodology produces a number of output reports. The output reports are used to (i) help make future investment decisions that correct underlying performance issues (root causes), and (ii) help disseminate information about one particular project; performance information predominantly. Examples of output reports are reflected in FIGS. 5, 6 and 7, referenced below. Some of these reports do not require additional input from the user, while others are used to drive additional automated activities or solicit manual intervention.

Referring to FIG. 5, an exemplary initial auto-generated inference report comprises an indication of those project parameter that have the most significant contribution to project performance. This example inference contains the top 10 inferences that statistical analyses have shown materially affect the performance of a project. The report may also include a numerical value that represents the quality of the records that have been used (i.e., quality of model fit—R² as a percentage). The report may further comprise the number of records used for the analysis (i.e., degrees of freedom.

One of the main challenges presented by all of the decision points within a project (such as creation and variation (i.e. change)) is the ability to efficiently understand the most appropriate project make-up. For this purpose, it is necessary to consider multiple scenarios by rapidly interchanging the various project parameters, running analyses and reporting on predicted performance capabilities (i.e. variation). The inventive system can perform these tasks in a fraction of the time taken by existing approaches (i.e. manually).

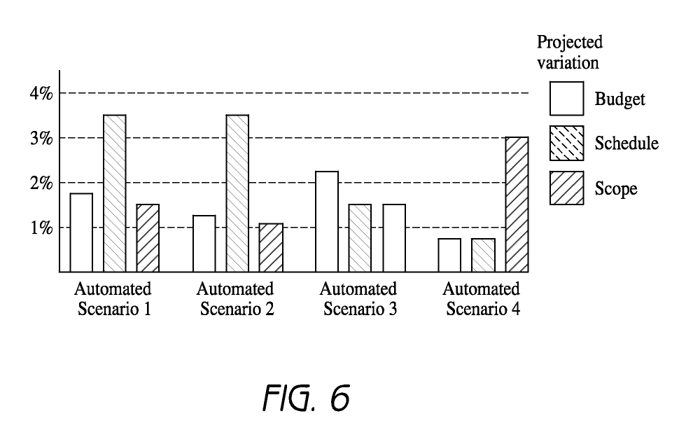

Referring to FIG. 6, multiple automated scenarios are reflected for the important characteristics of the project and the possible variation fluxuations in each scenario (e.g. scope (total requirements), schedule (total elapsed days (between project start and project closure) & financials (total budgeted expense). In scenario number 1, the budget and scope are contemplated to be varied by just under 2%, while the schedule is contemplated to be varied by about 3½%. An alternative scenario is shown in the other three sets with different predictive outcomes. Based upon these scenarios, the system selects the “best-fit” as a default value that resets the project parameters unless the project owner intervenes by selecting one of the other automated scenarios. A report like FIG. 6 enables the project owners to select the most appropriate project profile based on the overall commercial and technical needs of an individual project. Where the inventive system and methodology has been preconfigured to auto-select the project profile against a set of defined acceptable variable parameters (upper and lower specification levels), the solution is able to perform without manual intervention the analysis, identify the most suitable profile, create the project base line and ensure the recommended corrective measures and actions are assigned to the right individuals.

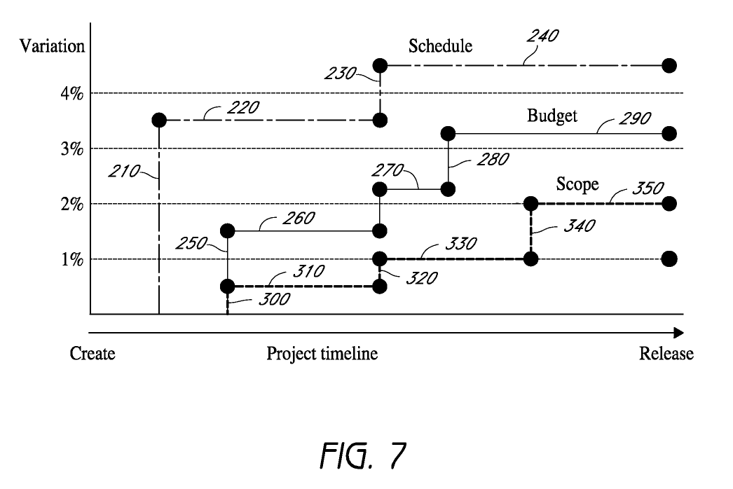

During the course of a project, the prime characteristics will vary within permissible constraints. Referring to FIG. 7, the inventive system records instances of variation throughout the project timeline. By way of example, the graph of FIG. 7 shows a first variation of 3½% in the schedule 210 where no change is made to the variation in the scope or budget. That schedule variation remains constant 220 until a later change in variation of about 1% is made 230, from which it remains constant 240 after that. In the meantime, following the initial change to the schedule 210, a change of 1½% variation to the budget 250 was made, from which it remained constant 260 until a further change of a bit less than 1% variation was made 270, that remained constant until further change 280 was made. At the time of the initial change to the budget 250, a ½% in scope 300 was made followed by a constancy 310 that continued until further variations 320 and 340. It is to be noted that not all variation changes reported are increases, but may be decreases as well. The report can reflect positive and negative changes, or it can merely reflect changes regardless of increase or decrease. For example, budget variation 250 may actually be a 1½% decrease in the allowable budget, rather than an increase. Moreover, total variation on scope, schedule and budget can be an accumulation of any independent changes to the parameters. An independent change may not have an impact on all three characteristics. For example, the first change impacts only the schedule 210.

Through the analysis of historical data at various stages within any given project (creation, change, closure and archive), the present inventive system and methodology removes the manual burden associated with collecting additional data, enables an automated process to generate multiple scenarios, each consisting of different project parameters and capable of predicting the best course of action to optimize operational and commercial performance. This business intelligence capability is continually applied throughout the duration of a project, capturing variation, inferences and status.

What is claimed is:

1. A system for enhancing the predictive value of planning of a pending project based upon data from historical projects, the system comprising:
means for storing historical data in a manner that permits later extraction of such data based upon similarity of characteristics, the means comprising a plurality of sectors into which relevant data from historical projects maybe stored;
means for storing conditional constraints on the project, the constraints comprising a limit on variation of at least one of either scope, schedule or budget; and
means for extracting certain subsets of historical data for purposes of performing statistical analyses on such data to enhance project planning as needed throughout the pendency of the pending project.

2. A method for enhancing the predictive value of planning of a pending project based upon data from historical projects, the method comprising:
storing historical data in a manner that permits later extraction of such data based upon similarity of characteristics, the data storing comprising storing subsets of data from similarly situated historical projects within one of a plurality of sectors;
extracting certain subsets of historical data for purposes of performing statistical analyses on such data to enhance project planning as needed throughout the pendency of the pending project;
generating a plurality of predictive scenarios by making a statistical analysis of the historical data in the context of conditional constraints, the constraints comprising a limit on variation of at least one of either scope, schedule or budget; and
selecting a best-fit scenario appropriate for the pending project.
